(19) United States
(12) Patent Application Publication
(10) Pub. No.: US 2011/0317867 A1
(43) Pub. Date: Dec. 29, 2011

(54) SPEAKER UNIT AND PORTABLE INFORMATION TERMINAL

(75) Inventors: Kazuyuki Kosuda, Osaka (JP); Yuki Hatanaka, Hyogo (JP)

(73) Assignee: SANYO ELECTRIC CO., LTD., Moriguchi-shi, Osaka (JP)

(21) Appl. No.: 13/142,229

(22) PCT Filed: Nov. 11, 2009
(86) PCT No.: PCT/JP2009/069205

§ 371 Date: Jun. 24, 2011

(30) Foreign Application Priority Data
Dec. 25, 2008 (JP) 2008-330968

(51) Int. Cl. H04R 9/06

(52) U.S. Cl. 381/398

(57) ABSTRACT

To provide a speaker unit and a portable information terminal suppressing a decrease in a vibration area and a reduction in a diaphragm edge portion path length caused along with miniaturization and slimming-down. A speaker unit includes a diaphragm member which has a first convex portion at an outer peripheral portion, a voice coil fixed to the diaphragm member, a magnet disposed to be spaced from the voice coil, and a frame which supports the magnet and has a second convex portion on a more inner peripheral side than the first convex portion. The diaphragm member is attached to the frame such that an inner peripheral surface of the first convex portion faces an outer peripheral surface of the second convex portion.

### TECHNICAL FIELD

The present invention relates to a speaker unit and a portable information terminal, and in particular to a speaker unit and a portable information terminal that are miniaturized and slimmed down.

### BACKGROUND ART

A speaker unit is used in a portable information terminal such as a mobile phone, a DSC (Digital Still Camera), a PDA (Personal Digital Assistant), a PC (Personal Computer), or the like. The speaker unit used herein includes so-called speaker and receiver. In the speaker unit, positioning of a diaphragm with respect to a frame is performed.

Conventionally, the positioning has been performed by an inner peripheral surface of a raised edge portion provided at an outer peripheral portion of the frame and an outer peripheral surface of the diaphragm. For example, Japanese Patent No. 3869782 (Patent Document 1) discloses a speaker apparatus in which a diaphragm is positioned by an inner peripheral surface of a raised edge portion provided at an outer peripheral portion of a frame and an outer peripheral surface of the diaphragm.

### Patent Document 1: Japanese Patent No. 3869782

### DISCLOSURE OF THE INVENTION

### Problems to be Solved by the Invention

Recently, portable information terminals have been miniaturized and slimmed down with an increasing speed. In response, space for mounting parts has been reduced in audio parts. Accordingly, there is an increasing market need for space-saving, higher-performance products.

However, if miniaturization and slimming-down are promoted with the shape of a conventional speaker unit being maintained, there arise problems described below. Specifically, when the speaker unit has a shape in which a diaphragm is positioned by a raised edge portion provided at an outer peripheral portion of a frame and an outer peripheral surface of the diaphragm, a vibration area in the speaker unit is decreased along with miniaturization and slimming-down. This arises a problem that the sound pressure of the speaker unit is reduced. Further, since the vibration area in the speaker unit is decreased, a diaphragm edge portion path length (a length of a portion located between a diaphragm edge portion and a voice coil, that is, a length of an arc portion in cross sectional view) is also reduced. This arises a problem that the lowest resonance frequency of the speaker unit is increased.

The present invention has been made in view of the aforementioned problems, and one object of the present invention is to provide a speaker unit and a portable information terminal suppressing a decrease in a vibration area and a reduction in a diaphragm edge portion path length caused along with miniaturization and slimming-down.

### Means for Solving the Problems

A speaker unit of the present invention includes a diaphragm member which has a first convex portion at an outer peripheral portion, a voice coil fixed to the diaphragm member, a magnet disposed to be spaced from the voice coil, and a frame which supports the magnet and has a second convex portion on a more inner peripheral side than the first convex portion. The diaphragm member is attached to the frame such that an inner peripheral surface of the first convex portion faces an outer peripheral surface of the second convex portion.

According to the speaker unit of the present invention, the diaphragm member is attached to the frame such that the inner peripheral surface of the first convex portion of the diaphragm member faces the outer peripheral surface of the second convex portion of the frame. By disposing the first and the second convex portions to face each other as described above, the diaphragm member can be positioned and fixed to the frame.

Further, the first convex portion of the diaphragm member is located on a more outer peripheral side than the second convex portion of the frame. Thus, a raised edge portion provided at an outer peripheral portion of a frame in the shape of a conventional speaker unit can be eliminated. Accordingly, in a case where the speaker unit of the present invention has external dimensions identical to those of the conventional speaker unit, the area of the diaphragm member can be further increased. Therefore, even if the speaker unit is miniaturized and slimmed down, it is possible to ensure that an vibrating portion of the diaphragm member has a large area, when compared with the shape of the conventional speaker unit. Consequently, a reduction in the sound pressure can be suppressed.

Further, since it is possible to ensure that the vibrating portion of the diaphragm member has a large area even if the speaker unit is miniaturized and slimmed down, a reduction in a diaphragm edge portion path length can also be suppressed, and an increase in the lowest resonance frequency can also be suppressed.

Preferably, in the speaker unit described above, the diaphragm member includes a diaphragm and a ring attached to an outer peripheral portion of the diaphragm. An inner peripheral surface of the ring, as the inner peripheral surface of the first convex portion, faces the outer peripheral surface of the second convex portion.

Preferably, in the speaker unit described above, the diaphragm member includes a diaphragm. The diaphragm has an outer peripheral convex portion at an outer peripheral portion, and an inner peripheral surface of the outer peripheral convex portion, as the inner peripheral surface of the first convex portion, faces the outer peripheral surface of the second convex portion.

Preferably, in the speaker unit described above, the second convex portion is continuously provided on an entire inner peripheral side of the frame.

Thereby, the diaphragm member can be positioned to the frame more stably.

Preferably, in the speaker unit described above, the second convex portion is at least partially provided on an inner peripheral side of the frame.

Thereby, the diaphragm member can be stably positioned to the frame.

A portable information terminal of the present invention includes any of the speaker units described above.

According to the portable information terminal of the present invention, since it includes any of the speaker units described above, even if external dimensions of the frame are reduced as miniaturization and slimming-down are promoted, a decrease in the area of the diaphragm can be suppressed, when compared with the shape of the conventional speaker unit. Further, a reduction in the diaphragm edge portion path length can be suppressed. Thereby, a reduction in the sound pressure of the speaker unit can be suppressed. Further, an increase in the lowest resonance frequency can be suppressed.

### Effects of the Invention

As explained above, according to the speaker unit and the portable information terminal of the present invention, a decrease in a vibration area and a reduction in a diaphragm edge portion path length caused along with miniaturization and slimming-down can he suppressed.

### BEST MODES FOR CARRYING OUT THE INVENTION

Hereinafter, embodiments of the present invention will be described with reference to the drawings.

### Embodiment 1

Firstly, a configuration of a speaker unit in the present embodiment will be described.

FIG. 1 is a schematic cross sectional view showing a speaker unit in the present embodiment. FIG. 2 is a schematic plan view of the speaker unit shown in FIG. 1. In FIG. 2, a diaphragm and a cover are not shown for easier visualization.

Referring to FIGS. 1 and 2, a speaker unit 20 in the present embodiment mainly has a diaphragm member 1, a voice coil 4, a magnet 5, a frame 7, a plate 8, a yoke 9, and a cover 10.

Diaphragm member 1 has a diaphragm 2 and a ring 3. Diaphragm 2 is composed of a thin plate to be capable of vibrating in an up-down direction (i.e., a direction indicated by an arrow A in FIG. 1). Diaphragm 2 is formed of, for example, a synthetic resin. Diaphragm 2 has a central portion 21 that is circular in plan view, a flat portion 22 formed on an outer peripheral side of central portion 21, a peripheral portion 23 formed on an outer peripheral side of flat portion 22, and an outer peripheral portion 24 formed on an outer peripheral side of peripheral portion 23. Central portion 21 and peripheral portion 23 are formed in arc shapes in cross sectional view in FIG. 1. Flat portion 22 is formed in a flat shape in cross sectional view in FIG. 1.

Annular ring 3 is attached to a lower surface of outer peripheral portion 24 of diaphragm 2. Ring 3 constitutes a first convex portion. Ring 3 is formed of, for example, a metal.

An upper surface of annular voice coil 4 is bonded to a lower surface of flat portion 22 of diaphragm 2, and thereby diaphragm 2 is attached to voice coil 4.

Magnet 5 is disposed on an outer peripheral side of voice coil 4 to be spaced from an outer peripheral surface of voice coil 4. Yoke 9 has a portion disposed on an inner peripheral side of voice coil 4 to be spaced from an inner peripheral surface of voice coil 4 (i.e., an inner peripheral side portion), and a portion disposed below voice coil 4 and magnet 5 (i.e., a lower side portion). The lower side portion of yoke 9 is disposed to be spaced from a lower surface of voice coil 4, and magnet 5 is placed on the lower side portion of yoke 9. In addition, plate 8 is disposed on an upper surface of magnet 5. There is a known outer magnet type in which magnet 5, plate 8, and yoke 9 constitute a magnetic circuit. There is also a known inner magnet type.

Frame 7 supports magnet 5, plate 8, and yoke 9 at a lower portion on an inner peripheral side thereof. Further, diaphragm member 1 is attached to an upper portion of frame 7.

A second convex portion 6 is formed at the upper portion of frame 7. The second convex portion 6 is located on a more inner peripheral side than ring 3 corresponding to the first convex portion, and, for example, is continuously provided on the entire periphery to be circular as shown in FIG. 2.

Diaphragm member 1 is attached to frame 7 such that an inner peripheral surface of ring 3 (the first convex portion) faces an outer peripheral surface of convex portion 6 (the second convex portion) provided on the inner peripheral side of frame 7.

Cover 10 that is circular in plan view is disposed to cover diaphragm 2. Cover 10 is formed in the shape of a trapezoid toward an upper surface. Cover 10 is attached to diaphragm 2 such that an upper surface of outer peripheral portion 24 of diaphragm 2 faces a lower surface of an outer peripheral portion of cover 10.

Next, an operation of the speaker unit in the present embodiment will be described.

With the above configuration, a magnetic flux generated from magnet 5 is guided by plate 8 and yoke 9, and converged into a gap in which voice coil 4 is disposed, generating a magnetic field. Then, when a current flows through voice coil 4, voice coil 4 vibrates up and down by the current flowing through voice coil 4 and the magnetic field generated from magnet 5, based on Fleming's left-hand rule. Therefore, diaphragm 2 attached to voice coil 4 vibrates. Thereby, an electric signal (current) is converted into sound (vibration).

Although the case where the second convex portion 6 is provided on the entire inner peripheral side of frame 7 has been described above, the second convex portion 6 may be at least partially provided on the inner peripheral side of frame 7. FIG. 3 is a schematic plan view of the speaker unit in a case where the second convex portion 6 is at least partially provided on the inner peripheral side of frame 7. In FIG. 3, diaphragm 2 and cover 10 are not shown for easier visualization, as in FIG. 2. Referring to FIG. 3, the second convex portion 6 is provided at equally spaced four locations on the inner peripheral side of frame 7.

Further, although the case where the second convex portion 6 and frame 7 are provided to be circular in plan view has been described above, the second convex portion 6 and frame 7 may be provided to be rectangular in plan view. FIG. 4 is a schematic plan view of the speaker unit in a case where the second convex portion 6 and frame 7 are provided to be rectangular in plan view. In FIG. 4, diaphragm 2 and cover 10 are not shown for easier visualization, as in FIGS. 2 and 3. Referring to FIG. 4, the second convex portion 6 and frame 7 are provided to be rectangular in plan view. The second convex portion 6 is continuously provided on the entire inner peripheral side of frame 7. It is to be noted that a schematic cross sectional view taken along a line I-I in FIG. 4 is identical to FIG. 1.

Further, frame 7 may be provided to be rectangular in plan view, and the second convex portion 6 may be at least partially provided on the inner peripheral side of frame 7. FIGS. 5 and 6 are schematic plan views of the speaker unit in a case where frame 7 is provided to be rectangular in plan view, and the second convex portion 6 is at least partially provided on the inner peripheral side of frame 7. In FIG. 5, diaphragm 2 and cover 10 are not shown for easier visualization, as in FIG. 4.

Referring to FIG. 5, frame 7 is provided to be rectangular in plan view. The second convex portion 6 is provided at a central portion of each of the long side and the short side on the inner peripheral side of frame 7. It is to be noted that a schematic cross sectional view taken along a line I-I in FIG. 5 is identical to FIG. 1.

Further, referring to FIG. 6, frame 7 is provided to he rectangular in plan view. The second convex portion 6 is provided at the four corners on the inner peripheral side of frame 7.

Next, function and effect of the speaker unit in the present embodiment will be described in comparison with a conventional speaker unit.

FIG. 7 is a schematic cross sectional view showing a configuration of a conventional speaker unit. Conventional speaker unit 20 is different from the speaker unit with the configuration in Embodiment 1, in the configuration of the upper portion of frame 7. Specifically, conventional speaker unit 20 has a shape in which diaphragm 2 is positioned by an inner peripheral surface of a raised edge portion 71 provided on an outer peripheral side of frame 7 and a diaphragm outer peripheral surface 72.

Therefore, if miniaturization and slimming-down are promoted with the shape of conventional speaker unit 20 being maintained, the area of diaphragm 2 is decreased accordingly. Further, a diaphragm edge portion path length 11 (a length of a portion located between a diaphragm edge portion and voice coil 4, that is, a length of an arc portion in cross sectional view) is also reduced. More specifically, referring to FIG. 7, diaphragm edge portion path length 11 is a length of diaphragm 2 between the edge portion of diaphragm 2 (i.e., outer peripheral portion 24 of diaphragm 2) and flat portion 22 of diaphragm 2 in cross sectional view. As a result, a decrease in the area of diaphragm 2 causes a reduction in the sound pressure of speaker unit 20. Further, a reduction in diaphragm edge portion path length 11 causes an increase in the lowest resonance frequency.

In contrast, in speaker unit 20 in the present embodiment, diaphragm member 1 including diaphragm 2 and ring 3 is attached to frame 7 such that the inner peripheral surface of ring 3 constituting the first convex portion faces the outer peripheral surface of the second convex portion 6. Thus, diaphragm member 1 is positioned to frame 7. Thereby, the raised edge portion provided at an outer peripheral portion of the frame in the shape of conventional speaker unit 20 can be eliminated. Accordingly, in a case where speaker unit 20 in the present embodiment has external dimensions identical to those of conventional speaker unit 20, the area of diaphragm member 1 can be further increased, and diaphragm edge portion path length 11 can be increased.

Therefore, according to speaker unit 20 in the present embodiment, even if external dimensions of frame 7 are reduced as miniaturization and slimming-down are promoted, a decrease in the area of diaphragm 2 can be suppressed, when compared. with the shape of conventional speaker unit 20. Further, a reduction in diaphragm edge portion path length 11 can be suppressed. Thereby, a reduction in the sound pressure of speaker unit 20 can be suppressed. Further, an increase in the lowest resonance frequency can be suppressed.

In addition, when the second convex portion 6 is continuously provided on the entire inner peripheral side of frame 7, diaphragm member 1 including diaphragm 2 and ring 3 can be positioned to frame 7 more stably.

It is to be noted that, when the second convex portion 6 is at least partially provided on the inner peripheral side of frame 7, diaphragm member 1 including diaphragm 2 and ring 3 can be stably positioned to frame 7.

Further, since frame 7 may be provided to be rectangular, the degree of freedom in design is ensured.

### Embodiment 2

Firstly, a configuration of a speaker unit in the present embodiment will be described.

FIG. 8 is a schematic cross sectional view of a speaker unit in the present embodiment. The speaker unit in the present embodiment is different from that in Embodiment 1 mainly in that it has no ring 3.

Referring to FIG. 8, diaphragm member 1 has diaphragm 2. Diaphragm 2 has an outer peripheral convex portion 82 at outer peripheral portion 24. Outer peripheral portion 24 is directly attached to a frame upper surface 81. Outer peripheral convex portion 82 constitutes the first convex portion. Frame 7 has the second convex portion 6 on a more inner peripheral side than outer peripheral convex portion 82.

An inner peripheral surface of outer peripheral convex portion 82, as an inner peripheral surface of the first convex portion, is attached to frame 7 to face an outer peripheral surface of the second convex portion 6 provided on the inner peripheral side of frame 7. Thus, diaphragm member 1 is positioned to frame 7.

It is to be noted that, since the configuration of the present embodiment other than that is identical to the configuration of Embodiment 1 described above, identical elements will be designated by the same reference numerals, and the description thereof will not be repeated.

Next, function and effect of the speaker unit in the present embodiment will be described.

According to speaker unit 20 in the present embodiment, since it has the above configuration, it has an effect identical to that in Embodiment 1.

Further, according to speaker unit 20 in the present embodiment, since ring 3 is not attached, man-hour and the number of parts can be reduced When compared with Embodiment 1. Thereby, manufacturing cost can be reduced when compared with Embodiment 1.

In addition, when the second convex portion 6 is continuously provided on the entire inner peripheral side of frame 7, diaphragm member 1 including diaphragm 2 can be positioned to frame 7 more stably.

It is to be noted that the second convex portion 6 can be at least partially provided on the inner peripheral side of frame 7. For example, the second convex portion 6 can be provided at equally spaced four locations on the inner peripheral side of frame 7. Thereby, diaphragm member 1 including diaphragm 2 can be stably positioned to frame 7.

Further, frame 7 can be provided to he rectangular in plan view. Thereby, the degree of freedom in design is ensured. Even if frame 7 is rectangular, the second convex portion 6 can be continuously provided on the entire inner peripheral side of frame 7. Thereby, diaphragm member 1 including diaphragm 2 can be positioned to frame 7 more stably.

It is to be noted that, even if frame 7 is rectangular in plan view, the second convex portion 6 can be at least partially provided on the inner peripheral side of frame 7. For example, the second convex portion 6 can be provided at the central portion of each of the long side and the short side on the inner peripheral side of frame 7. Further, the second convex portion 6 can be provided at the four corners on the inner peripheral side of frame 7. Thereby, diaphragm member 1 including diaphragm 2 can be stably positioned to frame 7.

### Embodiment 3

Firstly, a configuration of a speaker unit in the present embodiment will be described.

FIG. 9 is a schematic cross sectional view of a speaker unit in the present embodiment. The speaker unit in the present embodiment is different from that in Embodiment 2 mainly in that ring 3 is attached to an upper surface of outer peripheral portion 24 of diaphragm 2.

Referring to FIG. 9, ring 3 is attached to the upper surface of outer peripheral portion 24 of diaphragm 2. Cover 10 is attached to an upper surface of ring 3.

On the upper surface of outer peripheral portion 24 of diaphragm 2, ring 3 is attached to be in contact with outer peripheral convex portion 82. An inner peripheral surface of outer peripheral convex portion 82, as an inner peripheral surface of the first convex portion, is attached to frame 7 to face an outer peripheral surface of the second convex portion 6 provided on an inner peripheral side of frame 7. Thus, diaphragm member 1 is positioned to frame 7.

It is to he noted that, since the configuration of the present embodiment other than that is identical to the configuration of Embodiment 2 described above, identical elements will be designated by the same reference numerals, and the description thereof will not be repeated.

Next, function and effect of the speaker unit in the present embodiment will be described.

According to speaker unit 20 in the present embodiment, since it has the above configuration, it has an effect identical to that in Embodiment 1.

According to speaker unit 20 in the present embodiment, since ring 3 is attached to the upper surface of outer peripheral portion 24 of diaphragm 2, diaphragm member 1 can be easily attached to frame 7 by holding ring 3. That is, handling during assembly is improved.

In addition, when the second convex portion 6 is continuously provided on the entire inner peripheral side of frame 7, diaphragm member 1 including diaphragm 2 and ring 3 can be positioned to frame 7 more stably.

It is to be noted that the second convex portion 6 can be at least partially provided on the inner peripheral side of frame 7. For example, the second convex portion 6 can be provided at equally spaced four locations on the inner peripheral side of frame 7. Thereby, diaphragm member 1 can be positioned to frame 7.

Further, frame 7 can be provided to be rectangular in plan view. Thereby, the degree of freedom in design is ensured. Even if frame 7 is rectangular, the second convex portion 6 can be continuously provided on the entire inner peripheral side of frame 7. Thereby, diaphragm member 1 including diaphragm 2 can be positioned to frame 7 more stably.

It is to be noted that, even if frame 7 is rectangular in plan view, the second convex portion 6 can be at least partially provided on the inner peripheral side of frame 7. For example, the second convex portion 6 can be provided at the central portion of each of the long side and the short side on the inner peripheral side of frame 7. Further, the second convex portion 6 can be provided at the four corners on the inner peripheral side of frame 7. Thereby, diaphragm member 1 including diaphragm 2 can be stably positioned to frame 7.

Although the outer magnet type speaker unit in which the magnet is disposed on a more outer peripheral side than the voice coil has been described above, an inner magnet type speaker unit in which a magnet is disposed on a more inner peripheral side than a voice coil may be used. A configuration thereof will now be described. Since the configuration is identical to the configuration of Embodiment 1 described above unless otherwise specified, identical elements will be designated by the same reference numerals, and the description thereof will not be repeated.

FIG. 12 is a schematic cross sectional view showing a configuration of an inner magnet type speaker unit in the present embodiment. Referring to FIG. 12, magnet 5 is disposed on an inner peripheral side of voice coil 4 to be spaced from an inner peripheral surface of voice coil 4. Yoke 9 has a portion disposed on an outer peripheral side of voice coil 4 to be spaced from an outer peripheral surface of voice coil 4 (i.e., an outer peripheral side portion), and a portion disposed below voice coil 4 and magnet 5 (i.e., a lower side portion).

The lower side portion of yoke 9 is disposed to be spaced from a lower surface of voice coil 4, and magnet 5 is disposed on a central portion of the lower side portion of yoke 9. Yoke 9 is fixed by fitting into an inner peripheral surface of frame 7, on an outer peripheral side of the outer peripheral side portion. Frame 7 supports magnet 5 via yoke 9. In addition, plate 8 is disposed on an upper surface of magnet 5.

Also in this configuration, as in the outer magnet type speaker unit described above, diaphragm member 1 has diaphragm 2 and ring 3. Annular ring 3 is attached to a lower surface of outer peripheral portion 24 of diaphragm 2. Ring 3 constitutes the first convex portion. Further, diaphragm member 1 is attached to an upper portion of frame 7. The second convex portion 6 is formed at the upper portion of frame 7. The second convex portion 6 is located on a more inner peripheral side than ring 3 corresponding to the first convex portion. Diaphragm member 1 is attached to frame 7 such that an inner peripheral surface of ring 3 (the first convex portion) faces an outer peripheral surface of convex portion 6 (the second convex portion) provided on an inner peripheral side of frame 7. Cover 10 that is circular in plan view is disposed to cover diaphragm 2.

Next, an operation of the speaker unit having this configuration will be described. With this configuration, a magnetic flux generated from magnet 5 is guided by plate 8 and yoke 9, and converged into a gap in which voice coil 4 is disposed, generating a magnetic field. Then, when a current flows through voice coil 4, voice coil 4 vibrates up and down by the current flowing through voice coil 4 and the magnetic field generated from magnet 5, based on Fleming's left-hand rule. Therefore, diaphragm 2 attached to voice coil 4 vibrates.

Although the speaker unit equipped with the voice coil having a shape in which the number of stacked layers in a thickness direction is greater than the number of stacked layers in a width direction has been described above, a speaker unit equipped with a voice coil having a shape in which the number of stacked layers in the width direction is greater than the number of stacked layers in the thickness direction may be used. A configuration thereof will now be described.

FIG. 13 is a schematic cross sectional view showing a configuration of a speaker unit equipped with a voice coil having a shape in which the number of stacked layers in the width direction is greater than the number of stacked layers in the thickness direction in the present embodiment. Referring to FIG. 13, diaphragm member 1 has diaphragm 2. Diaphragm 2 has outer peripheral convex portion 82 constituting the first convex portion at outer peripheral portion 24. Outer peripheral portion 24 is directly attached to frame upper surface 81. Diaphragm 2 has a disk shape.

An upper surface of voice coil 4 is bonded to a central portion of a lower surface of diaphragm 2, and thereby voice coil 4 is attached to diaphragm 2. Voice coil 4 has a cylindrical shape. Magnet 5 is fixed to a central portion of cover 10, and disposed to be spaced from an upper surface of diaphragm 2.

Cover 10 has a shape of a cylinder with one open end. In cover 10, a plurality of small holes 73 for emitting sound are circumferentially provided. Frame 7 has a shape of a cylinder with one open end that has an outer diameter equal to that of cover 10. The second convex portion 6 is formed on an inner peripheral side of frame 7. Frame 7 and cover 10 are bonded to each other at openings thereof. Frame 7 supports magnet 5 via cover 10.

Outer peripheral portion 24 of diaphragm 2 is fixed by being sandwiched between frame 7 and cover 10. An inner peripheral surface of outer peripheral convex portion 82, as an inner peripheral surface of the first convex portion, is attached to frame 7 to face an outer peripheral surface of the second convex portion 6 provided on the inner peripheral side of frame 7.

Next, an operation of this configuration will be described. A magnetic flux M (indicated by dashed arrows in FIG. 13) is emitted from magnet 5. Magnetic flux M passes through a gap G, and acts on voice coil 4. Then, voice coil 4 vibrates due to a change in a current supplied to voice coil 4. Therefore, diaphragm 2 attached to voice coil 4 vibrates.

Next, function and effect of this configuration will be described. According to speaker unit 20 equipped with voice coil 4 having the above shape, the number of stacked layers in a direction intersecting a central axis T of voice coil 4 (i.e., the width direction) is greater than the number of stacked layers in a direction of central axis T (i.e., the thickness direction). Therefore, voice coil 4 can be made thinner, and speaker unit 20 equipped with voice coil 4 can be made thinner.

Further, in the speaker unit equipped with the voice coil having the shape in which the number of stacked layers in the width direction is greater than the number of stacked layers in the thickness direction, a plurality of magnets may be mounted. A configuration thereof will now be described. Since the configuration is identical to the configuration of Embodiment 1 described above unless otherwise specified, identical elements will be designated by the same reference numerals, and the description thereof will not be repeated.

FIG. 14 is a schematic cross sectional view showing a configuration of a speaker unit equipped with a voice coil having a shape in which the number of stacked layers in the width direction is greater than the number of stacked layers in the thickness direction and a plurality of magnets in the present embodiment. Referring to FIG. 14, voice coil 4 is disposed above an upper surface of magnet 5 to be spaced therefrom. Voice coil 4 is disposed such that a magnetic flux generated by magnet 5 crosses voice coil 4.

Magnet 5 is magnetized in a direction parallel to central axis T. Magnet 5 includes a pair of rectangular solid outer magnets 51 and a rectangular solid inner magnet 52. Magnet 5 is fixed with outer peripheral surfaces of outer magnets 51 fitting into an inner peripheral surface of frame 7. Yoke 9 is disposed below magnet 5 and frame 7. Magnet 5 is disposed on a central portion of an upper surface of yoke 9. Yoke 9 is fixed with an upper surface of a peripheral portion and a side surface of yoke 9 fitting into frame 7. Frame 7 supports magnet 5 at the inner peripheral surface, and via yoke 9.

FIG. 15(A) is a schematic perspective view of magnet 5 in FIG. 14. Referring to FIG. 15, the pair of outer magnets 51 and inner magnet 52 are magnetized in opposite directions. Specifically, the pair of outer magnets 51 is magnetized such that lower surfaces thereof become N poles, and inner magnet 52 is magnetized such that an upper surface thereof becomes an N pole. It is only necessary to magnetize the pair of outer magnets 51 and inner magnet 52 in opposite directions. Therefore, the pair of outer magnets 5.1 may be magnetized such that upper surfaces thereof become N poles, and inner magnet 52 may be magnetized such that a lower surface thereof becomes an N pole.

Also in this configuration, as in the outer magnet type speaker unit described above, diaphragm member 1 has diaphragm 2 and ring 3. Annular ring 3 is attached to a lower surface of outer peripheral portion 24 of diaphragm 2. Ring 3 constitutes the first convex portion. Further, diaphragm member 1 is attached to an upper portion of frame 7. The second convex portion 6 is formed at the upper portion of frame 7. The second convex portion 6 is located on a more inner peripheral side than ring 3 corresponding to the first convex portion. Diaphragm member 1 is attached to frame 7 such that an inner peripheral surface of ring 3 (the first convex portion) faces an outer peripheral surface of convex portion 6 (the second convex portion) provided on an inner peripheral side of frame 7. Cover 10 that is circular in plan view is disposed to cover diaphragm 2.

Next, an operation of the speaker unit having this configuration will be described. With this configuration, a magnetic flux generated from magnet 5 is converged into a gap in which voice coil 4 is disposed, generating a magnetic field. Then, when a current flows through voice coil 4, voice coil 4 vibrates up and down by the current flowing through voice coil 4 and the magnetic field generated from magnet 5, based on Fleming's left-hand rule. Therefore, diaphragm 2 attached to voice coil 4 vibrates.

Next, function and effect of the speaker unit having this configuration will be described. As described above, outer magnets 51 and inner magnet 52 are magnetized in opposite directions. Thus, a magnetic flux formed by the upper surfaces of outer magnets 51 and the upper surface of inner magnet 52 is superimposed on a magnetic flux formed by the lower surfaces of outer magnets 51 and the lower surface of inner magnet 52. Therefore, a high-density magnetic flux passes through voice coil 4. Thereby, drive force acting on the diaphragm is increased, and thus sound pressure can be increased.

In addition, a structure in which a surface of inner magnet 52 more projects toward voice coil 4 than surfaces of outer magnets 51 as shown in FIG. 15(B) can be employed. In this structure, a magnetic flux is formed at a location closer to voice coil 4. Thus, a higher-density magnetic flux passes through voice coil 4. Thereby, drive force acting on the diaphragm is further increased, and thus sound pressure can be further increased.

### Embodiment 4

Firstly, a configuration of a portable information terminal in the present embodiment will be described.

FIGS. 10 and 11 are schematic perspective views of a portable information terminal in the present embodiment. Referring to FIGS. 10 and 11, the portable information terminal in the present embodiment is a mobile phone, mainly including an upper casing 101, a display portion 102, a sound emission hole 103, a hinge portion 104, a lower casing 105, operation buttons 106, numeric buttons 107, a display portion 111, a sound emission hole 112, and speaker unit 20 (not shown) according to any of Embodiments 1 to 3.

Referring to FIG. 10, display portion 102 is provided in a front surface of upper casing 101. Sound emission hole 103 is formed on one end side of the front surface of upper casing 101. Hinge portion 104 is formed on the other end side of upper casing 101. Hinge portion 104 is formed on one end side of lower casing 105. Upper casing 101 and lower casing 105 are coupled by hinge portion 104 to be capable of being opened and closed. Operation buttons 106 are formed in a front surface of lower casing 105, on a side close to hinge portion 104. Numeric buttons 107 are formed adjacent to operation buttons 106, on a side opposite to hinge portion 104.

Referring to FIG. 11, display portion 111 is provided in a rear surface of upper casing 101. Sound emission hole 112 is formed adjacent to display portion 111.

Speaker unit 20 (not shown) according to any of Embodiments 1 to 3 and FIGS. 12 to 15 is provided inside upper casing 101. Sound is emitted from speaker unit 20, mainly through sound emission holes 103 and 112, out of the portable information terminal.

Next, function and effect of the portable information terminal in the present embodiment will be described.

According to the portable information terminal in the present embodiment, since it includes speaker unit 20 according to any of Embodiments 1 to 3 and FIGS. 12 to 15 described above, even if external dimensions of frame 7 are reduced as miniaturization and slimming-down are promoted, a decrease in the area of diaphragm 2 can be suppressed, when compared with the shape of conventional speaker unit 20. Further, a reduction in diaphragm edge portion path length 11 can be suppressed. Thereby, a reduction in the sound pressure of speaker unit 20 can be suppressed. Further, an increase in the lowest resonance frequency can be suppressed.

In addition, according to the portable information terminal in the present embodiment, a smaller portable information terminal can be obtained by promoting miniaturization and slimming-down. Further, the degree of freedom in design can be improved by including space-saving speaker unit 20. Furthermore, a dial tone, a ring tone, and the like can be clearly perceived by increasing sound pressure.

Although the mobile phone has been described as the portable information terminal in the present embodiment, the portable information terminal is not limited thereto, and may be a DSC, a PDA, a PC, or the like.

it should be understood that the embodiments disclosed herein are illustrative and non-restrictive in every respect. The scope of the present invention is defined by the scope of the claims, rather than the description above, and is intended to include any modifications within the scope and meaning equivalent to the scope of the claims.

### INDUSTRIAL APPLICABILITY

The present invention is particularly advantageously applicable to a speaker unit and a portable information terminal that are miniaturized and slimmed down.

### BRIEF DESCRIPTION OF THE DRAWINGS

FIG. 1 is a schematic cross sectional view of a speaker unit in Embodiment 1.

FIG. 2 is a schematic plan view of the speaker unit in Embodiment 1.

FIG. 3 is a schematic plan view of the speaker unit in Embodiment 1.

FIG. 4 is a schematic plan view of the speaker unit in Embodiment 1.

FIG. 5 is a schematic plan view of the speaker unit in Embodiment 1.

FIG. 6 is a schematic plan view of the speaker unit in Embodiment 1.

FIG. 7 is a schematic cross sectional view of a conventional speaker unit.

FIG. 8 is a schematic cross sectional view of a speaker unit in Embodiment 2.

FIG. 9 is a schematic cross sectional view of a speaker unit in Embodiment 3.

FIG. 10 is a schematic perspective view of a portable information terminal in Embodiment 4.

FIG. 11 is a schematic perspective view of the portable information terminal in Embodiment 4.

FIG. 12 is a schematic cross sectional view of an inner magnet type speaker unit in an embodiment.

FIG. 13 is a schematic cross sectional view of a speaker unit equipped with a voice coil having a shape in which the number of stacked layers in a width direction is greater than the number of stacked layers in a thickness direction in an embodiment.

FIG. 14 is a schematic cross sectional view of a speaker unit equipped with a voice coil having a shape in which the number of stacked layers in the width direction is greater than the number of stacked layers in the thickness direction and a plurality of magnets in an embodiment.

FIG. 15(A) is a perspective view of the magnets in FIG. 14, and FIG. 15(B) is a perspective view of magnets having a structure in which a surface of an inner magnet more projects toward a voice coil than surfaces of outer magnets.

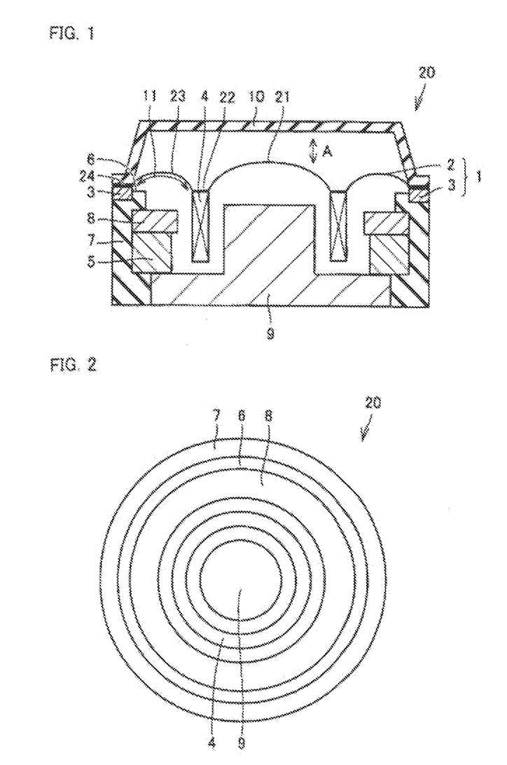

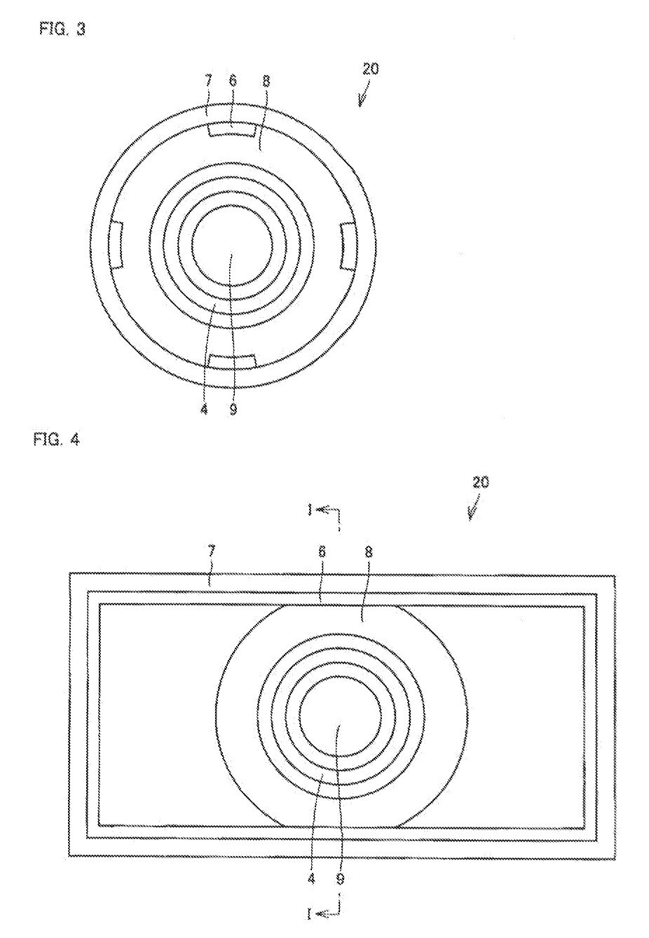

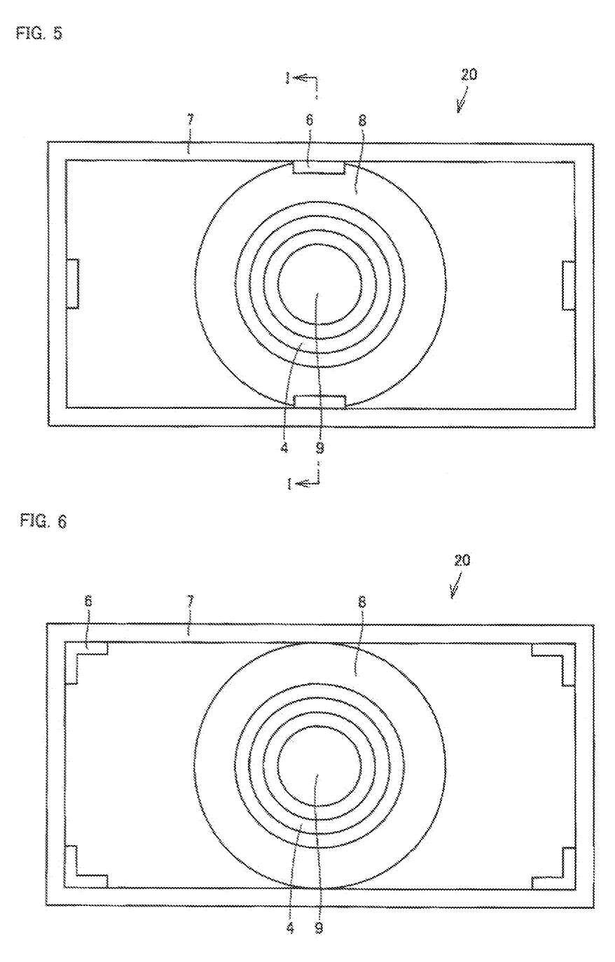

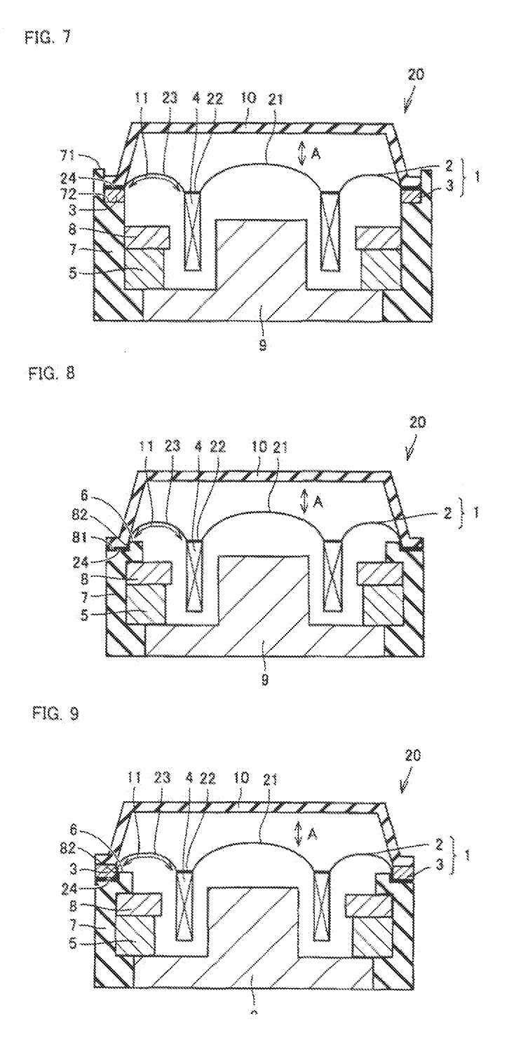

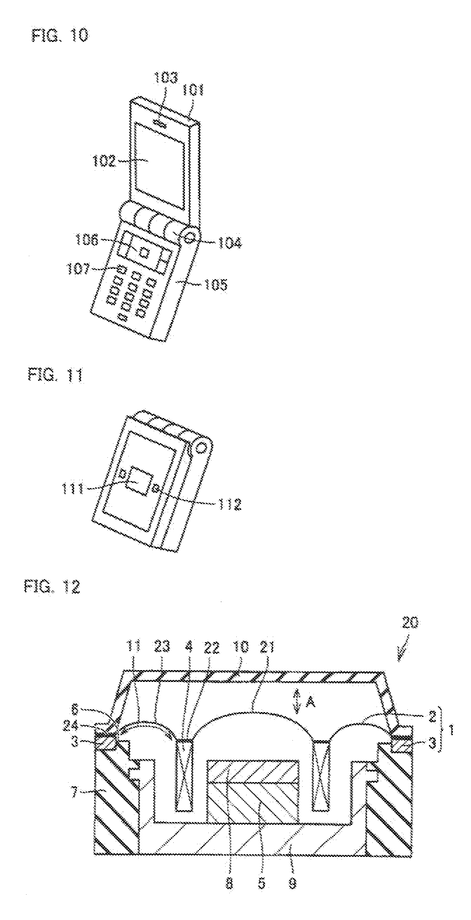

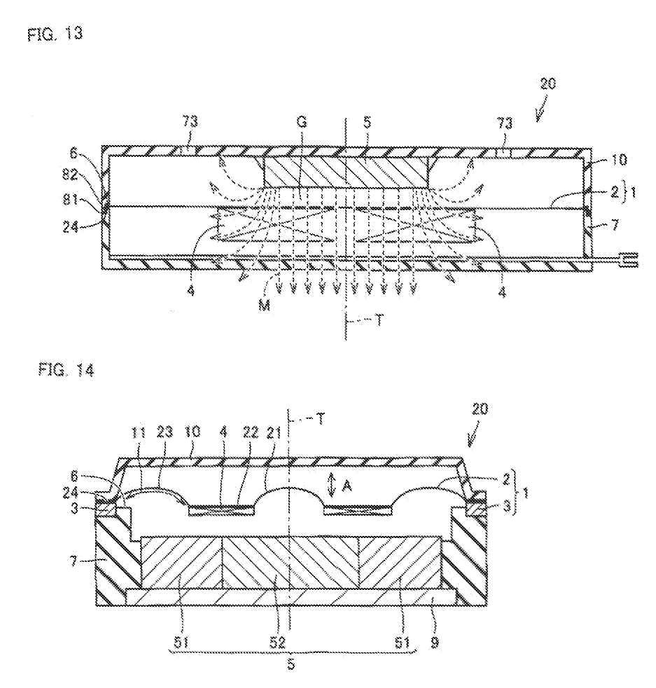

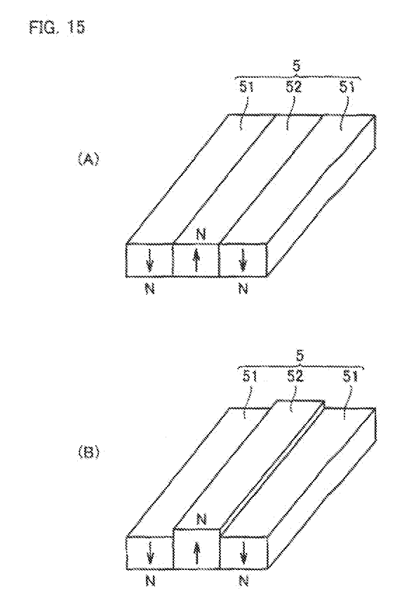

### DESCRIPTION OF THE REFERENCE SIGNS

1: diaphragm member, 2: diaphragm, 3: ring, 4: voice coil, 5: magnet, 6: second convex portion, 7: frame, 8: plate, 9: yoke, 10: cover, 11: diaphragm edge portion path length, 20: speaker unit, 21: central portion, 22: flat portion, 23: peripheral portion, 24: outer peripheral portion, 71: raised edge portion, 72: diaphragm outer peripheral surface, 81: frame upper surface, 101: upper casing, 102: display portion, 103: sound emission hole, 1.04: hinge portion, 105: lower casing, 106: operation buttons, 107: numeric buttons, 111: display portion, 112: sound emission hole.

1. A speaker unit, comprising:
a diaphragm member which has a first convex portion at an outer peripheral portion;
a voice coil fixed to said diaphragm member;
a magnet disposed to be spaced from said voice coil; and
a frame which supports said magnet and has a second convex portion on a more inner peripheral side than said first convex portion,
wherein said diaphragm member is attached to said frame such that an inner peripheral surface of said first convex portion faces an outer peripheral surface of said second convex portion.

2. The speaker unit according to claim 1, wherein
said diaphragm member includes a diaphragm and a ring attached to an outer peripheral portion of said diaphragm, and
an inner peripheral surface of said ring, as the inner peripheral surface of said first convex portion, faces the outer peripheral surface of said second convex portion.

3. The speaker unit according to claim 1, wherein
said diaphragm member includes a diaphragm, and
said diaphragm has an outer peripheral convex portion at an outer peripheral portion, and an inner peripheral surface of said outer peripheral convex portion, as the inner peripheral surface of said first convex portion, faces the outer peripheral surface of said second convex portion.

4. The speaker unit according to claim 1, wherein said second convex portion is continuously provided on an entire inner peripheral side of said frame.

5. The speaker unit according to claim 1, wherein said second convex portion is at least partially provided on an inner peripheral side of said frame.

6. A portable information terminal including the speaker unit according to claim 1.
